(19) United States
(12) Patent Application Publication
(10) Pub. No.: US 2009/0057282 A1
(43) Pub. Date: Mar. 5, 2009

(54) Laser machining method utilizing variable inclination angle

(76) Inventors: Chunfu Huang, Peoria, IL (US); Zhaoli Hu, Dunlap, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/222,658

(22) Filed: Aug. 13, 2008

Related U.S. Application Data
(60) Provisional application No. 60/935,477, filed on Aug. 15, 2007.

(51) Int. Cl. B23K 26/00

(52) U.S. Cl. 219/121.71; 219/121.72

(57) ABSTRACT

A method of laser machining is disclosed. The method of laser machining may include directing a laser beam emitted by an optical device onto a workpiece at an inclination angle to create a cut in the workpiece and varying the inclination angle of the laser beam.

### RELATED APPLICATIONS

This application claims priority to U.S. Provisional Patent Application Ser. No. 60/935,477, filed Aug. 15, 2007, the contents of which are expressly incorporated herein by reference.

### TECHNICAL FIELD

The present disclosure relates generally to a laser machining method, and more particularly, to a method of laser machining using a variable inclination angle.

### BACKGROUND

When performing a laser machining operation, an operator typically causes a laser to rotate about a central axis of a focusing lens to define the edges of the desired hole. In order to create a taper in the sides of the laser drilled hole, the laser beam does not pass directly though the center of the focusing lens. Instead, the laser beam enters the lens parallel to, but not collinear with the central axis of the lens. The lens bends the laser beam, causing the beam to reach the workpiece at an angle relative to the center axis of the lens. This angle, known as the inclination angle, depends on the lens geometry and the distance between the laser beam and the center axis of the lens. Varying the distance between the laser beam and the central axis will change the inclination angle. During conventional laser machining, however, the laser beam remains at a constant distance from the central axis, resulting in a constant inclination angle.

Conventional laser machining techniques that maintain a constant inclination angle often result in unwanted defects in the workpiece. For example, due to the inclination angle, undercuts may be formed in the hole wall. These undercuts may result in unsteady flow when the hole is intended to act as a fluid passage. Another problem encountered with common laser machining techniques is the formation of material clouds as the laser cuts through the workpiece. These clouds reduce the laser power density and effect plasma ablation, resulting in undesired heat accumulation and material melting that, in turn, affect the material surface properties, reduce the precision of the hole dimensions, and reduce fatigue life.

One method of reducing the number of defects in a laser machined workpiece is described in U.S. Pat. No. 6,070,813 (the '813 patent) issued to Durheim. In particular, the '813 patent discloses a method of forming a nozzle. The method includes focusing a laser beam so that its focal point is located on an outer surface of a tip portion of the nozzle for a first period of time. During the first period of time, a passageway is created and waste product is deposited at the periphery of the passageway. The method further includes the step of refocusing the laser beam so that its focal point is located above the outer surface of the tip portion of the nozzle for a second period of time. During the second period of time, the laser disintegrates the waste product.

Although the method of laser machining disclosed in the '813 patent may reduce defects in a nozzle that result from waste deposit, the method may not be well suited for all applications. In particular, the method of the '813 patent may not reduce the formation of undercuts in the hole wall or material clouds.

The disclosed laser machining method is directed to overcoming one or more of the shortcomings set forth above.

### SUMMARY OF THE DISCLOSURE

In one aspect, the present disclosure is directed toward a method of laser machining. The method may include directing a laser beam emitted by an optical device onto a workpiece at an inclination angle to create a cut in the workpiece and varying the inclination angle of the laser beam.

In another aspect, the present disclosure is directed toward another method of laser machining. The method may include directing a laser beam at a workpiece at an inclination angle, inducing plasma ablation in the workpiece, and inducing formation of a molten material in the workpiece. The method may further include varying the inclination angle to reduce an amount of material cloud formed by the molten material.

In another aspect, the present disclosure is to a method of forming a tapered hole. The method may include forming a pilot hole in a workpiece, directing a laser beam at the workpiece at an inclination angle to create a cut in the workpiece and varying the inclination angle of the laser beam while continuing to create the cut in the workpiece.

### BRIEF DESCRIPTION OF THE DRAWINGS

FIG. 1 is a pictorial illustration of the disclosed laser machining method.

### DETAILED DESCRIPTION

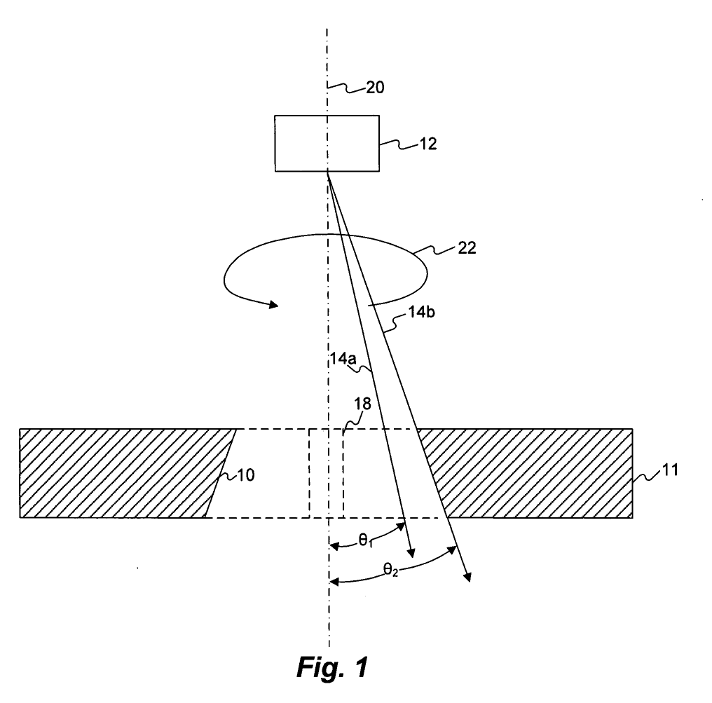

FIG. 1 illustrates an exemplary method of laser machining a tapered hole 10 in a workpiece 11. The method may include the use of an optical device 12 that may include a laser and a lens (not shown). The optical device may produce a laser beam 14 directed onto workpiece 11.

Prior to laser machining of tapered hole 10, a pilot hole 18 may be formed in workpiece 11. Pilot hole 18 may be formed within the bounds of desired tapered hole 10. For example, the diameter of pilot hole 18 may be about ten percent of the diameter of desired tapered hole 10. It is further considered that the diameter of pilot hole 18 may be determined based on the desired depth of tapered hole 10.

To create tapered hole 10 within workpiece 11, laser beam 14 may be directed onto workpiece 11 in a direction that is non-collinear with a central axis 20 of optical device 12. Optical device 12 may bend laser beam 14, causing beam 14 to reach workpiece 11 at an angle θ relative to the central axis 20 and workpiece 11. This angle is known as the inclination angle. The inclination angle may be a function of geometry of the lens contained within optical device 12. Optical device 12 may be capable of varying inclination angle θ of the emitted beam. For example, FIG. 1 shows beams 14a and 14b directed at two different inclination angles, θ₁ and θ₂, respectively, where θ₂>θ₁. Beam 14 may be rotated about central axis 20, as shown by arrow 22.

### INDUSTRIAL APPLICABILITY

The disclosed method of laser machining utilizing variable inclination angle may be applicable to a wide variety of components including, for example, fuel injector nozzles. It is further considered that the disclosed method may also be applied to laser machining of features other than tapered holes, such as, for example, straight cuts along a workpiece edge. An exemplary method for laser machining utilizing variable inclination angle will now be described in detail.

Referring to FIG. 1, pilot hole 18 may be drilled into workpiece 11 along the axis of desired tapered hole 10. The diameter of pilot hole 18 may be dependant upon the depth and diameter of desired tapered hole 10. For example, the diameter of pilot hole 18 may be about ten percent of the desired final diameter of tapered hole 10. Pilot hole 18 may be formed by laser drilling or other drilling means.

Optical device 12 may direct a beam 14a onto workpiece 11, with an inclination angle θ₁. Optical device 12 may rotate beam 14 about axis 20 as shown by arrow 22. The rotating beam 14 may induce plasma ablation, resulting in a hole within workpiece 11. Beam 14 may also induce the formation of material clouds formed by the molten material of workpiece 11. This material may flow through pilot hole 18.

As the depth of the hole formed by beam 14 increases, it may be desirable to alter the inclination angle of the beam emitted by optical device 12 in order to avoid the formation of undercuts in the sidewall of tapered hole 10. For example, optical device 12 may be controlled to direct a beam 14b with an inclination angle θ₂, where inclination angle θ₂ is greater than inclination angle θ₁.

Determining the manner in which inclination angle θ may vary may require an iterative process and may be dependant upon the geometry and material properties of workpiece 11, the configuration of optical device 12, the position of optical device 12 relative to workpiece 11, and the desired geometry of tapered hole 10. It is considered that holes with a varying taper may be achieved by varying inclination angle θ and that varying the inclination angle θ may include both increasing and decreasing θ. Once the optimal set of inclination angle variations have been determined for a particular configuration, the same set of inclination angle variations may be applied to similar workpieces. For example, all workpieces laser machined on an assembly line may require a standard set of inclination angle variations.

The disclosed method may result in laser machined features with increased dimensional precision and without undesirable undercuts. Furthermore, the pilot hole of the disclosed method may enable plasma and other undesirable material clouding to escape without affecting the geometry of the tapered hole and inducing undesirable changes in the material properties of the workpiece surface.

It will be apparent to those skilled in the art that various modifications and variations can be made to the disclosed method of laser machining utilizing variable inclination angle. Other embodiments will be apparent to those skilled in the art from consideration of the specification and practice of the disclosed method. It is intended that the specification and examples be considered as exemplary only, with a true scope being indicated by the following claims and their equivalents.

What is claimed is:

1. A method of laser machining, comprising:
directing a laser beam emitted by an optical device onto a workpiece at an inclination angle to create a cut in the workpiece; and
varying the inclination angle of the laser beam.

2. The method of claim 1, further including rotating the laser beam about a central axis of the optical device.

3. The method of claim 1, wherein directing the laser beam includes directing the laser beam through the optical device at an angle offset from a central axis of the optical device.

4. The method of claim 3, wherein varying the inclination angle of the laser beam includes varying an angle of the laser beam from the central axis of the optical device.

5. The method of claim 1, wherein varying the inclination angle includes increasing the inclination angle as a depth of the cut relative to the workpiece increases.

6. The method of claim 1, further including forming a pilot hole in the workpiece prior to the directing step.

7. The method of claim 6, wherein directing the laser beam onto the workpiece includes causing at least a portion of the workpiece to form a molten material and the method further includes allowing the molten material to flow through the pilot hole.

8. The method of claim 1, wherein varying the inclination angle of the laser beam includes varying the inclination angle based upon at least one of a geometry of the workpiece, a material property of the workpiece, a configuration of the optical device, a position of the optical device relative to the workpiece, or a desired geometry of the cut in the workpiece.

9. A method of laser machining, comprising:
directing a laser beam at a workpiece at an inclination angle;
inducing plasma ablation in the workpiece;
inducing formation of a molten material in the workpiece; and
varying the inclination angle to reduce an amount of material cloud formed by the molten material.

10. The method of claim 9, further including forming a pilot hole in the workpiece prior to the directing step.

11. The method of claim 10, further including allowing the molten material to flow through the pilot hole.

12. The method of claim 9, wherein varying the inclination angle includes increasing the inclination angle as a depth of a cut in the workpiece increases.

13. The method of claim 9, further including rotating the laser beam.

14. The method of claim 9, further including rotating the laser beam and wherein varying the inclination angle includes increasing the inclination angle as a depth of a cut in the workpiece increases.

15. A method of forming a tapered hole comprising:
forming a pilot hole in a workpiece;
directing a laser beam at the workpiece at an inclination angle to create a cut in the workpiece;
varying the inclination angle of the laser beam to while continuing to create the cut in the workpiece.

16. The method of claim 15, wherein directing the laser beam includes directing the laser beam at a perimeter of the pilot hole.

17. The method of claim 15, further including rotating the laser beam.

18. The method of claim 15, wherein varying the inclination angle includes both increasing and decreasing the inclination angle.

19. The method of claim 15, further including allowing a molten material to flow through the pilot hole.

20. The method of claim 15, wherein directing the laser beam includes directing the laser beam at a perimeter of the pilot hole and the method further includes allowing molten material to flow through the pilot hole.
